(19) United States
(12) Patent Application Publication
(10) Pub. No.: US 2021/0194536 A1
(43) Pub. Date: Jun. 24, 2021

(54) METHOD AND APPARATUS FOR INCLUDING SYSTEM INFORMATION IN A FREQUENCY HOPPING SYSTEM

(71) Applicant: Sony Corporation, Tokyo (JP)

(72) Inventors: Kare AGARDH, Lund (SE); Rickard LJUNG, Lund (SE)

(21) Appl. No.: 17/057,368

(22) PCT Filed: Apr. 17, 2019
(86) PCT No.: PCT/SE2019/050356

§ 371 Date: Nov. 20, 2020

(30) Foreign Application Priority Data
May 25, 2018 (SE) 1830174-7

(51) Int. Cl. H04B 1/713; H04J 11/00; H04W 72/04

(52) U.S. Cl. CPC H04B 1/713; H04W 72/0453; H04J 11/0073

(57) ABSTRACT

An access point (12) in a frequency hopping system includes system information based on a target periodicity and a predetermined frequency range. The access point selects frames for system information transmissions from among transmission opportunities within the frequency range as determined according to a frequency hopping sequence. An electronic device (14) monitors frequencies of the frequency range in parallel to detect the system information.

### RELATED APPLICATION DATA

This applications claims the benefit of Swedish Patent Application No. 1830174-7, filed May 25, 2018, the disclosure of which is incorporated herein by reference in its entirety.

### TECHNICAL FIELD OF THE INVENTION

The technology of the present disclosure relates generally to wireless communications among electronic devices in a network environment and, more particularly, to a method and apparatus for including system information in a frequency hopping communication system.

### BACKGROUND

Demand for data traffic on wireless communication systems continues to increase. Since widespread commercialization of fourth generation (4G) wireless systems, such as a Long Term Evolution (LTE) system or an LTE-Advanced (LTE-A) system standardized by the 3rd Generation Partnership Project (3GPP), additional wireless systems are being developed. To meet demand for higher data rates and to target other use cases and deployment scenarios, wireless systems anticipate using unlicensed spectrum bands. For example, there are several projects exploring LTE-based systems that leverage unlicensed radio spectrum.

One such system is LTE-U, which is being developed by the LTE-U Forum. LTE-U intends to use the unlicensed 5 GHz band already utilized by WiFi devices for some data traffic. LTE-U, however, relies on licensed spectrum for control signaling. Another variant standardized by the 3GPP is Licensed Assisted Access (LAA), which is similar to LTE-U in some respects. For instance, LAA utilizes licensed spectrum for some communications. Another technology is MulteFire, which is driven by the MulteFire Alliance. Unlike LTE-U and LAA, MulteFire only uses unlicensed spectrum.

Regulatory agencies require a system to employ frequency when utilizing unlicensed spectrum. For wireless communication systems exclusively using unlicensed spectrum, such as MulteFire, transmission of system information may not utilize a fixed resource allocation as with licensed spectrum systems without sacrificing randomness of a frequency hopping sequence.

### SUMMARY

The disclosed approach provides opportunities for system information transmissions in unlicensed spectrum without reducing randomness of or otherwise altering a frequency hopping scheme. An access point may define a target periodicity for transmitting system information and, based on the target periodicity, may define a plurality of target transmission occurrences. To enable fast and reliable reception of the system information, the access point utilizes transmission opportunities that fall within a predetermined frequency range in accordance with a frequency hopping sequence. The access point may select frames, within the frequency, to transmit system information based at least in part on the target periodicity and/or target transmission occurrences. A user equipment (UE) may receive the system information by monitoring frequencies in the frequency range in parallel.

According to one aspect of the disclosure, a method for transmitting system information in a frequency hopping communications system includes determining a frequency range for the system information transmission and a target system information transmission occurrence; selecting a transmission frame occurring in the frequency range for transmission of the system information based at least in part on the target system information transmission occurrence; and transmitting the system information in the transmission frame selected.

According to one embodiment of the method, selecting the frame includes selecting a first frame in the frequency range following the target system information transmission occurrence.

According to another embodiment, a method for transmitting system information in a frequency hopping communications system includes obtaining a frequency range for the system information transmission; selecting a frame occurring in the frequency range for transmission of the system information based on a target system information transmission periodicity; and transmitting the system information in the frame selected. In one embodiment, obtaining includes determining or obtaining the frequency range from a predetermined range and/or obtaining it from another entity (e.g. a communication network entity).

According to another embodiment of the method, selecting the frame comprises selecting a first frame in the frequency range following a target system information transmission occurrence, wherein the target system information transmission occurrence is based on the target system information transmission periodicity.

According to another embodiment of the method, selecting the frame includes selecting a frame within the frequency range that is nearest, in the time domain, to target system information transmission occurrence.

According to one embodiment of the method, the frequency range is one or more channels of a hopping spectrum of the frequency hopping communication system.

According to one embodiment of the method, the frequency range is two or more channels of a hopping spectrum of the frequency hopping communication system.

According to one embodiment of the method, the frequency range is based on a receiving bandwidth of an electronic device receiving the system information.

According to one embodiment of the method, an occurrence of the frame in the frequency range is determined by a frequency hopping sequence, which is different for every period of the target system information transmission periodicity.

According to one embodiment of the method, the method further includes transmitting device-specific signaling and/or device-specific data in any frame within the frequency range not selected for transmission of the system information.

According to one embodiment of the method, the method further includes repeating frame selection and transmission of the system information to generate system information transmissions having periodicity substantially aligned to the target system information transmission periodicity.

According to another aspect of the disclosure, an access point in a frequency hopping communication system includes a wireless interface over which wireless communications with electronic devices are carried out across a system bandwidth in accordance with a frequency hopping sequence; and a control circuit configured to control transmission of a system information by the access point, wherein the control circuit causes the access point to: determine a frequency range for the system information transmission and a target system information transmission occurrence; select a frame occurring in the frequency range for transmission of the system information based at least in part on the target system information transmission occurrence; and transmit the system information in the frame selected.

According to one embodiment of the access point, the control circuit further causes the access point to select a first frame in the frequency range following the target system information transmission occurrence.

According to another aspect, an access point in a frequency hopping communication system includes a wireless interface over which wireless communications with electronic devices are carried out across a system bandwidth in accordance with a frequency hopping sequence; and a control circuit configured to control transmission of a system information by the access point, wherein the control circuit causes the access point to: obtain a frequency range for the system information transmission; select a frame occurring in the frequency range for transmission of the system information based on a target system information transmission periodicity; and transmit the system information in the frame (46) selected.

According to one embodiment of the access point, the control circuit further causes the access point to select a first frame in the frequency range following a target system information transmission occurrence, wherein the target system information transmission occurrence is based on the target system information transmission periodicity.

According to one embodiment of the access point, the control circuit further causes the access point to select a nearest frame, in time, within the frequency range to the target system information transmission occurrence.

According to one embodiment of the access point, the frequency range is one or more channels of a hopping spectrum of the frequency hopping communication system.

According to one embodiment of the access point, the frequency range is two or more channels of a hopping spectrum of the frequency hopping communication system.

According to one embodiment of the access point, the frequency range is based on a receiving bandwidth of the electronic devices receiving the system information.

According to one embodiment of the access point, an occurrence of the frame in the frequency range is determined by the frequency hopping sequence. which is different for every period of the target system information transmission periodicity.

According to one embodiment of the access point, the control circuit further causes the access point to transmit device-specific signaling and/or device-specific data in any frame within the frequency range not selected for transmission of the system information.

According to one embodiment of the access point, the control circuit further causes the access point to repeat frame selection and transmission of the system information to result in system information transmissions having periodicity substantially aligned to the target system information transmission periodicity.

According to another aspect of the disclosure, a method of receiving system information in an electronic device operating in a wireless communication system having a frequency hopping sequence includes listening to frames transmitted within a frequency range of a hopping spectrum designated for transmission of system information; and; receiving the system information in at least one frame within the frequency range, wherein the at least one frame on which the system information is received is based at least in part on a target system information transmission periodicity.

According to one embodiment of the method, listening to frames transmitted within a frequency range includes monitoring all channels of the frequency range in parallel.

According to one embodiment of the method, the frequency range is one or more channels of the hopping spectrum.

According to one embodiment of the method, the frequency range is two or more channels of the hopping spectrum.

According to one embodiment of the method, the frequency range is based on a receiving bandwidth of the electronic device receiving the system information.

According to one embodiment of the method, the at least one frame includes a first frame in the frequency range following a target system information transmission occurrence, wherein the target system information transmission occurrence is based on the target system information transmission periodicity.

According to one embodiment of the method, the at least one frame includes a frame within the frequency range that is nearest, in the time domain, to the target system information transmission occurrence.

According to another aspect of the disclosure, an electronic device includes a wireless interface over which wireless communications with an access point are carried out across a system bandwidth in accordance with a frequency hopping sequence; and a control circuit configured to control the electronic device, wherein the control circuit configures the electronic device to: listen to frames transmitted within a frequency range of a hopping spectrum designated for transmission of system information; and receive the system information in at least one frame within the frequency range, wherein the at least one frame during which the system information is received is based at least in part on a target system information transmission periodicity.

According to one embodiment of the electronic device, the frequency range is one or more channels of the hopping spectrum.

According to one embodiment of the electronic device, the frequency range is two or more channels of the hopping spectrum.

According to one embodiment of the electronic device, the frequency range is based on a receiving bandwidth of the electronic device.

According to one embodiment of the electronic device, the control circuit further causes the electronic device to monitor frequencies in the frequency range in parallel.

According to one embodiment of the electronic device, the at least one frame is a first frame in the frequency range following a target system information transmission occurrence, wherein the target system information transmission occurrence is based on the target system information transmission periodicity.

According to one embodiment of the electronic device, the at least one frame is a frame in the frequency range that is nearest, in the time domain, to the target system information transmission occurrence.

### BRIEF DESCRIPTION OF THE DRAWINGS

FIG. 1 is a schematic block diagram of a network communication system that selects opportunities for system information transmission in accordance with a frequency hopping scheme in unlicensed radio spectrum communications.

FIG. 2 is a schematic block diagram of an electronic device that forms part of the network communication system of FIG. 1.

FIG. 3 is a schematic diagram of a technique to select frames for system information transmissions.

FIG. 4 is a schematic diagram of a technique to select frames for system information transmissions.

FIG. 5 is a flow-diagram of a representative method of transmitting system information by an access point of the network communication system.

FIG. 6 is a flow-diagram of a representative method of receiving system information at an electronic device of the network communication system.

### DETAILED DESCRIPTION OF EMBODIMENTS

### Introduction

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below, in conjunction with the appended figures, are various embodiments of systems and methods for providing system information in a frequency hopping system. Transmission frames for system information may be selected from among transmission opportunities occurring within a predetermined frequency range in accordance with a frequency hopping sequence. The transmission occurrences may be selected based at least in part on a target periodicity. A wideband receiver may receive the system information transmission by monitoring an entirety of the frequency range in parallel.

### System Architecture

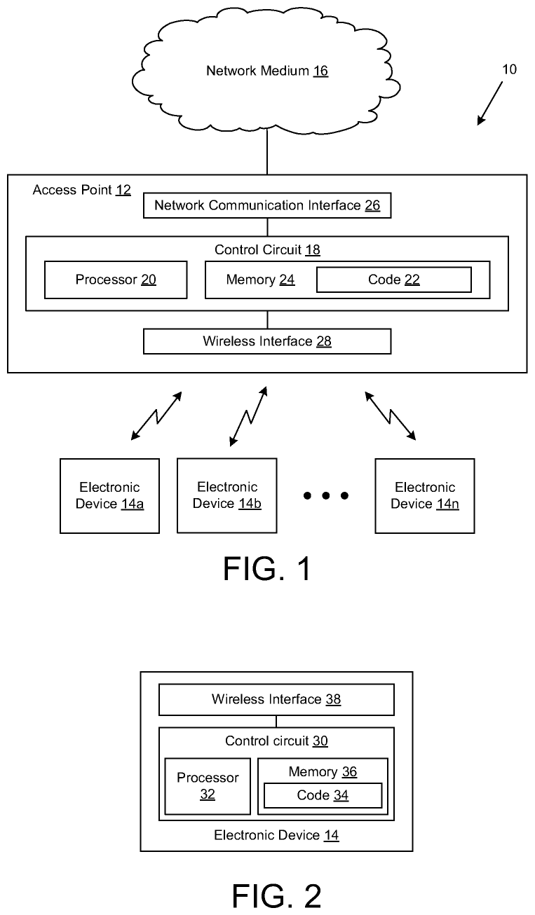

FIG. 1 is a schematic diagram of an exemplary network communication system 10 for implementing the disclosed techniques. It will be appreciated that the illustrated communication system is representative and other systems may be used to implement the disclosed techniques. The exemplary network communication system 10 includes an access point 12 that may operates in accordance with a cellular or other wireless communication protocol, such as a protocol promulgated by 3GPP or another standard. For instance, the network communication system 10 may operate in accordance with the MulteFire standard. However, it is to be appreciated that the techniques described herein can be applied to substantially any wireless or wired communication system that utilizes frequency hopping.

The network communication system 10 of the illustrated example supports cellular-type protocols, which may include circuit-switched network technologies and/or packet-switched network technologies. The network communication system 10 includes an access point 12 that services one or more electronic devices 14, designated as electronic devices 14a through 14n in FIG. 1. The access point 12 may support communications between the electronic devices 14 and a network medium 16 through which the electronic devices 14 may communicate with other electronic devices 14, servers, devices on the Internet, etc. The access point 12 may be an access point, an evolved NodeB (eNB) in a 4G network or a next generation NodeB (gNB) in a 5G or NR network. As utilized herein, the term “access point” may refer, generally, to any device that services user devices and enables communications between the user devices and the network medium and, thus, includes the specific examples above depending on the network implementation.

Network communication system 10 may be a frequency hopping system. In such a system, the access point 12 schedules resources, in time and frequency, utilized for transmissions in accordance with a random (or pseudo-random) hopping sequence. As an example a formula, program code or other method of how to generate a varying sequence may be provided and described in a specification of a communication system standard documentation (e.g. a MulteFire standard). Such varying sequence is typically denoted pseudo random since it may look like a random varying hopping sequence due to the variations in the hopping. However, when such a sequence generation formula is known in combination with detailed information indicative of where in the hopping sequence a system is currently operating it is possible to calculate further instances of the future hopping. In this manner a device connected to a communication system using such hopping sequence can be aware of the frequency hopping sequence and adjust its radio communication accordingly.

For example, for portions of an 900 MHz band, a channel may be narrow (e.g., on the order of 200 kHz) and the system may employ a random or pseudo-random sequence of 50 or more channels. Thus, the system utilizes resources one channel at a time over a hopping spectrum that is N times greater than the channel bandwidth, where N is a length of the hopping sequence. For a connected electronic device 14, appropriate system information may be received, and used possibly in combination with pre-defined sequence generation information (e.g. provided in a standardization documentation) to enable the electronic device 14 to follow the frequency hopping sequence. However, for an electronic device 14 performing initial access or otherwise unsynchronized (e.g. due to being in a dormant mode a period of time such as during an extended DRX period), the hopping sequence or when a certain transmission occurrence of the hopping sequence will occur may be unknown. Accordingly, system information may be transmitted with sufficient regularity or accessibility to enable the electronic device 14 to detect, synchronize, and attach to the network communication system 10 without excessive delay. Such system information may include, without limitation, a primary synchronization signal (PSS), secondary synchronization signal (SSS), a broadcast channel (BCH), etc. In general, system information is broadcasted information for purposes including, but not limited to, informing devices about timing alignments (e.g. synchronization signals) to know where frames start and end, frame numbering to understand where in time within a sequence the system is currently operating, cell specific information (e.g. cell identity, cell configuration, etc.), cell specific parameter configurations for devices, paging indicators, etc.

As described herein, the access point 12 may select transmission opportunities for the system information in accordance with a particular scheme in order to enable electronic devices 14 to quickly detect the system information despite the randomness of the system's resource utilization. The access point 12 may include operational components for carrying out resource selection as described herein, general wireless communications, and other functions of the access point 12. For instance, the access point 12 may include a control circuit 18 that is responsible for overall operation of the access point 12, including controlling the access point 12 to carry out the operations described in greater detail below. The control circuit 18 includes a processor 20 that executes code 22, such as an operating system and/or other applications. The functions described in this disclosure document may be embodied as part of the code 22 or as part of other dedicated logical operations of the access point 12. The logical functions and/or hardware of the access point 12 may be implemented in other manners depending on the nature and configuration of the access point 12. Therefore, the illustrated and described approaches are just examples and other approaches may be used including, but not limited to, the control circuit 18 being implemented as, or including, hardware (e.g., a microprocessor, microcontroller, central processing unit (CPU), etc.) or a combination of hardware and software (e.g., a system-on-chip (SoC), an application-specific integrated circuit (ASIC), etc.).

The code 22 and any stored data (e.g., data associated with the operation of the access point 12) may be stored on a memory 24. The code may be embodied in the form of executable logic routines (e.g., a software program) that is stored as a computer program product on a non-transitory computer readable medium (e.g., the memory 24) of the access point 12 and is executed by the processor 20. The functions described as being carried out by the access point 12 may be thought of as methods that are carried out by the access point 12.

The memory 24 may be, for example, one or more of a buffer, a flash memory, a hard drive, a removable media, a volatile memory, a non-volatile memory, a random access memory (RAM), or other suitable device. In a typical arrangement, the memory 24 includes a non-volatile memory for long term data storage and a volatile memory that functions as system memory for the control circuit 18. The memory 24 is considered a non-transitory computer readable medium.

The access point 12 includes communications circuitry that enables the access point 12 to establish various communication connections. For instance, the access point 12 may have a network communication interface 26 to communicate with the network medium 16. Also, the access point 12 may have a wireless interface 28 over which wireless communications are conducted with the electronic devices 14, including the system information transmissions described herein. The wireless interface 28 may include a radio circuit having one or more radio frequency transceivers (also referred to as a modem), at least one antenna assembly, and any appropriate tuners, impedance matching circuits, and any other components needed for the various supported frequency bands and radio access technologies.

The electronic devices 14 serviced by the access 12 may be user devices, also known as user equipment or UEs, or machine-type devices. Exemplary electronic devices 14 include, but are not limited to, mobile radiotelephones (such as “smartphones”), tablet computing devices, computers, a device that uses machine-type communications, machine-to-machine (M2M) communications or device-to-device (D2D) communication (e.g., a sensor, a machine controller, an appliance, etc.), a camera, a media player, or any other device that conducts wireless communications with the access point 12.

As shown in FIG. 2, each electronic device 14 may include operational components for carrying out the wireless communications, the system information reception described herein and other functions of the electronic device 14. For instance, among other components, each electronic device 14 may include a control circuit 30 that is responsible for overall operation of the electronic device 14, including controlling the electronic device 14 to carry out the operations described in greater detail below. The control circuit 30 includes a processor 32 that executes code 34, such as an operating system and/or other applications. The functions described in this disclosure document may be embodied as part of the code 34 or as part of other dedicated logical operations of the electronic device 14. The logical functions and/or hardware of the electronic device 14 may be implemented in other manners depending on the nature and configuration of the electronic device 14. Therefore, the illustrated and described approaches are just examples and other approaches may be used including, but not limited to, the control circuit 30 being implemented as, or including, hardware (e.g., a microprocessor, microcontroller, central processing unit (CPU), etc.) or a combination of hardware and software (e.g., a system-on-chip (SoC), an application-specific integrated circuit (ASIC), etc.).

The code 34 and any stored data (e.g., data associated with the operation of the electronic device 14) may be stored on a memory 36. The code 34 may be embodied in the form of executable logic routines (e.g., a software program) that is stored as a computer program product on a non-transitory computer readable medium (e.g., the memory 36) of the electronic device 14 and is executed by the processor 32. The functions described as being carried out by the electronic device 14 may be thought of as methods that are carried out by the electronic device 14.

The memory 36 may be, for example, one or more of a buffer, a flash memory, a hard drive, a removable media, a volatile memory, a non-volatile memory, a random access memory (RAM), or other suitable device. In a typical arrangement, the memory 36 includes a non-volatile memory for long term data storage and a volatile memory that functions as system memory for the control circuit 30. The memory 36 is considered a non-transitory computer readable medium.

The electronic device 14 includes communications circuitry that enables the electronic device 14 to establish various communication connections. For instance, the electronic device 14 may have a wireless interface 38 over which wireless communications are conducted with the access point 12, including the system information transmission procedures described herein. The wireless interface 38 may include a radio circuit having one or more radio frequency transceivers (also referred to as a modem), at least one antenna assembly, and any appropriate tuners, impedance matching circuits, and any other components needed for the various supported frequency bands and radio access technologies.

Other components of the electronic device 14 may include, but are not limited to, user inputs (e.g., buttons, keypads, touch surfaces, etc.), a display, a microphone, a speaker, a camera, a sensor, a jack or electrical connector, a rechargeable battery and power supply unit, a SIM card, a motion sensor (e.g., accelerometer or gyro), a GPS receiver, and any other appropriate components.

### System Information Transmission Procedures for Frequency Hopping Systems

The network communication system 10 may utilize frequency hopping for transmissions between the access point 12 and the electronic devices 14 such that the access point 12 transmits frames at varying frequencies determined according to a random or pseudorandom frequency hopping sequence. As utilized herein, the terms “frame” or “transmission frame” refer to a period of time during which the communication system employs a particular group or frequency resources (e.g. a particular channel). That is, during the frame, the communication system does not employ any other group of frequency resources. The network communication system 10 may operate entirely in unlicensed spectrum such that control signaling and system information is also transmitted in unlicensed spectrum in addition to payload or user data. Accordingly, control signaling and system information transmissions may also be subject to frequency hopping.

A wireless communication system (i.e. an LTE system or NR system, for example) may generally transmit system information regularly in order for user devices to detect. For non-hopping systems, a given frequency and period for the transmission may be known. Frequency hopping, however, may disrupt an exact periodicity of transmissions at an exact frequency due to randomness (or pseudo-randomness) of where and when frequency resources are utilized. Thus, frequency hopping systems may utilize other techniques to provide easy access for UEs. Some possible techniques sacrifice randomness in order to bring regularity or predictability to system information transmissions.

For example, in one technique, a system information periodicity determines when system information transmissions should occur. When these times occur, the system may override the random hopping sequence and transmit the system information at a predetermined frequency. The system returns to the random hopping sequence until a next system information transmission occurs. In another technique, a random hopping sequence may be discarded in favor of a predefined hopping pattern that repeats according to the system information periodicity. Thus, the system information transmission may occur at a predetermined frequency based on the predefined hopping pattern. Both of these techniques, however, sacrifice randomness of a hopping sequence.

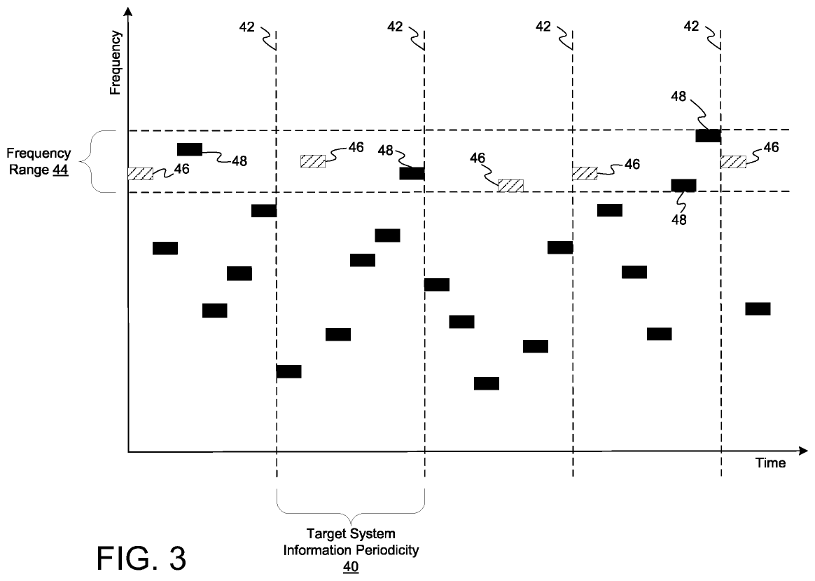

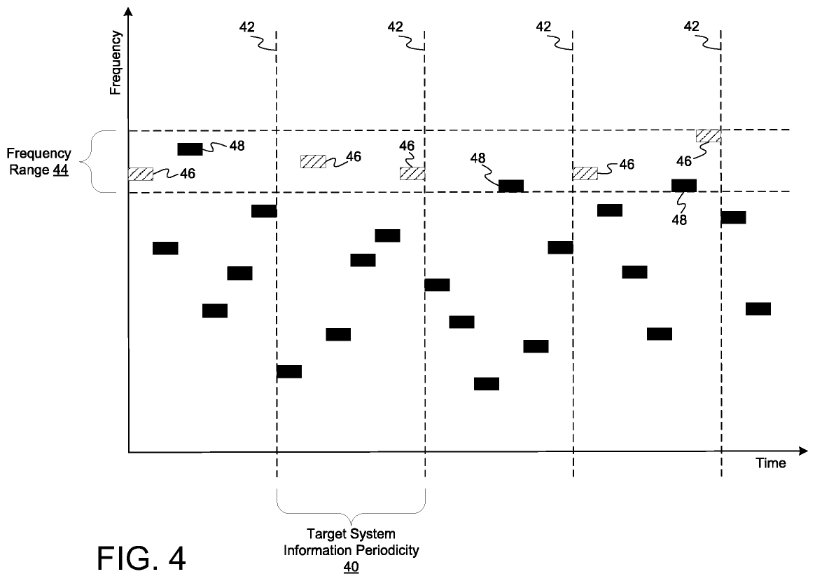

With reference to FIGS. 3 and 4, exemplary schematic diagrams depicting general procedures for communication system 10 to transmit system information in a frequency hopping system. The procedures schematically depicted in FIGS. 3 and 4 may be utilized by access point 12 and electronic devices 14 (e.g., UEs) to transmit and receive system information in frequency hopping systems employing unlicensed spectrum. Unlike the previous techniques, the procedures depicted in FIGS. 3 and 4 maintain a randomness of a frequency hopping sequence.

In FIGS. 3 and 4, a portion of system resources in a frequency domain and a time domain are illustrated. As shown, the system employs a frequency hopping sequence that is a random or pseudo-random pattern of frequencies used by the system for transmissions. More particularly, the frequency hopping sequence defines which channel (e.g. frequency) is utilized for a particular frame (e.g., time), with the constraint that only one channel is employed at a time.

To include system information transmission within the random scheme, the system defines a target system information periodicity 40, which in turn determines a plurality of target system information transmission occurrences 42 spaced in the time domain according to the periodicity 40. The target periodicity 40 and target occurrences 42 represent ideal transmission times for system information, but the system may not provide guaranteed timing due to the frequency hopping sequence. In one aspect, the target periodicity 40 may be an average or median periodicity sought by the system over time. However, a time between transmissions may vary from one transmission to another based on the frequency hopping sequence.

With the purpose of striving to achieve the target periodicity 40 and transmission at each target occurrence 42, the system defines a frequency range 44. The frequency range 44 is a portion of a hopping spectrum of the communication system. As utilized herein, the term “hopping spectrum” refers to a set of frequencies (e.g., channels) employed by a communication system in its particular frequency hopping sequence. For example, a communication system may be configured to utilize N channels one at a time according to a random or pseudo-random pattern. The N channels are considered the system's hopping spectrum. As shown in FIGS. 3 and 4, the frequency range 44 may include one or more channels of the hopping spectrum. The one or more channels of frequency range 44 may be contiguous in the frequency domain or may be discontinuously arranged in the frequency range 44.

Based at least in part on the frequency range 44, the target periodicity 40, and/or the target transmission occurrences 42, the system may select particular frames in which to transmit system information. At the end of one frame, the system switches to a different channel for a next frame as determined by the frequency hopping sequence. A frame utilized to transmit system information is referred to as a system information frame 46 and any other frame not utilized for system information is referred to as a normal data frame 48.

Turning specifically to FIG. 3, one exemplary procedure for including system information transmissions in a frequency hopping sequence is depicted. According to this procedure, the system selects frames 46 to be system information frames in which system information is transmitted. The other frames 48 are non-system information frames. For instance, frames 48 may include other data (e.g., user data, payload data, dedicated data traffic, or device-specific data and control communications), which is not system information as described above.

In the technique shown in FIG. 3, the system selects a first frame following a given target transmission occurrence 42 that falls within the frequency range 44. In other words, when the system hops into the frequency range 44 according to the frequency hopping sequence and that hop is the first instance since a last target transmission occurrence 42 in time, system information is transmitted in frame 46. Other frames 48, which correspond to other hops into the frequency range 44 following frame 46 but before a next target transmission occurrence 42, may be utilized for other, non-system information data.

With particular reference to FIG. 4, an alternative technique to select frames for system information transmission is depicted. With this technique, the system selects any frame 46 falling within the frequency range 44 that is nearest, in the time domain, to a target transmission occurrence 42. Other frames 48, within the frequency range 44, that are not the closest in time to target transmission occurrences 42 may be utilized to transmit non-system information. As shown in FIG. 4, it may be possible that two system information frames 46 occur between two adjacent target transmission occurrences 42.

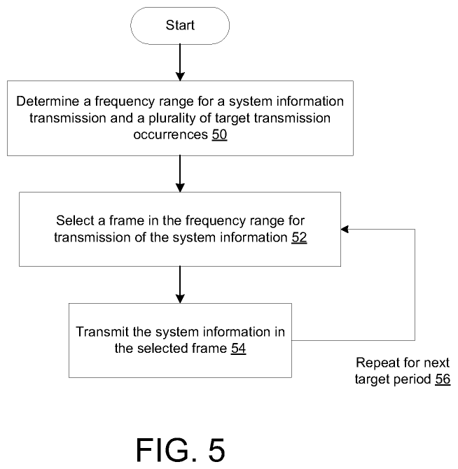

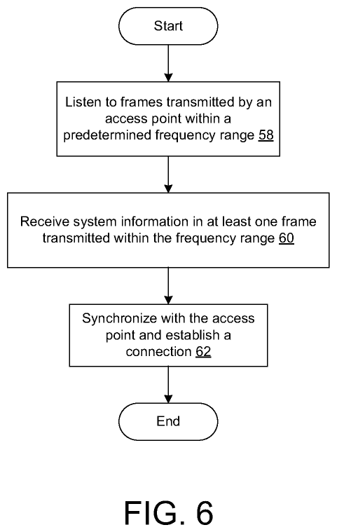

Turning to FIG. 5, shown is an exemplary flow diagram representing steps that may be carried out by the access point 12 when executing logical instructions to carry out system information transmissions for wireless radio communications using a frequency hopping system. Complimentary operations of the electronic device 14 are shown FIG. 6, which shows an exemplary flow diagram representing steps that may be carried out by the electronic device 14 when executing logical instructions to carry out receiving system information transmissions in a frequency hopping system. Although illustrated in a logical progression, the blocks of FIGS. 5 and 6 may be carried out in other orders and/or with concurrence between two or more blocks. Therefore, the illustrated flow diagrams may be altered (including omitting steps or adding steps not shown in order to enhance description of certain aspects) and/or may be implemented in an object-oriented manner or in a state-oriented manner. Also, the method represented by FIG. 5 may be carried out apart from the method of FIG. 6 and vice versa.

Referring to actions carried out by the access point 12, the logical flow of including system information in a frequency hopping system may start in block 50. It may be assumed that access point 12 changes a channel for each frame in accordance with a frequency hopping sequence. Accordingly, in block 50, the access point 12 determines a frequency range for system information transmissions and a target system information periodicity that defines a plurality of target system information transmission occurrences. These parameters establish a general framework for system information transmissions.

The access point 12 strives to repeat system information at intervals as close as possible to target intervals defined by the target periodicity. Thus, in block 52, the access point selects a frame within the frequency range for transmission of the system information. As utilized herein, a “frame within the frequency range” refers to any frame of the frequency hopping sequence corresponding to a frequency that falls within the frequency range. The frequency range may provide one or more channels that may be received in parallel by a UE. A wider band increases a likelihood of a frame occurring at a monitored channel at intervals approximating the target periodicity.

According to one technique (shown in FIG. 3), the access point 12 selects a first frame within the frequency range following a target system information transmission occurrence defined by the target system information periodicity. In another technique (FIG. 4), the access point 12 selects a frame closest to, in the time domain, a target system information transmission occurrence. Thus, the selected frame may be before or after a particular target system information transmission occurrence.

In block 54, the access point 12 transmits system information in the frame selected in block 52. Then, as indicated by reference 56, the access point 12 may repeat blocks 52 and 54 for a next target period (i.e. for a next target system information transmission occurrence).

Referring to FIG. 6, exemplary actions carried out by the electronic device 14 are illustrated. The actions carried out by the electronic device 14 may, in some case, be complementary to the actions carried out by the access point 12, which were described above. The logical flow of receiving system information by the electronic device 14 may start in block 58. In block 58, it may be assumed that electronic device 14 is configured to know a predetermined frequency range in which system information transmissions may occur. Accordingly, in block 58, the electronic device 14 listens for frames transmitted by access point 12 within the predetermined frequency range. The electronic device 14 may be a wideband receiver capable of monitoring the channels within the frequency range in parallel at the same time. In block 60, the electronic device 14 detects system information in at least one frame transmitted within the frequency range. For example, system information may include a synchronization signal (e.g. PSS or SSS) which may be detected by the electronic device 14 to learn a timing of the communication system. In block 62, the electronic device 14 may synchronize with the access point 12 and establish a connection 62. If the electronic device 14, is already synchronized and/or connected to access point 12, the electronic device 14 may utilize the system information, or a portion thereof, to maintain synchronization or perform channel estimation.

### CONCLUSION

Although certain embodiments have been shown and described, it is understood that equivalents and modifications falling within the scope of the appended claims will occur to others who are skilled in the art upon the reading and understanding of this specification.

1. A method of transmitting system information in a frequency hopping communications system, comprising:
determining a frequency range for the system information transmission and a target system information transmission occurrence;
selecting a transmission frame occurring in the frequency range for transmission of the system information based at least in part on the target system information transmission occurrence; and
transmitting the system information in the transmission frame selected.

2. The method of claim 1, wherein selecting the frame comprises selecting a first frame in the frequency range following the target system information transmission occurrence.

3. The method of claim 1, wherein selecting the frame comprises selecting a frame within the frequency range that is nearest, in the time domain, to the target system information transmission occurrence.

4. The method of claim 1, wherein the frequency range is one or more channels of a hopping spectrum of the frequency hopping communication system.

5. The method of claim 1, wherein the frequency range is based on a receiving bandwidth of an electronic device receiving the system information.

6. The method of claim 1, wherein an occurrence of the frame in the frequency range is determined by a frequency hopping sequence, which is different for every period of the target system information transmission periodicity.

7. The method of claim 1, further comprising transmitting device-specific signaling and/or device-specific data in any frame within the frequency range not selected for transmission of the system information.

8. The method of claim 1, further comprising repeating frame selection and transmission of the system information to generate system information transmissions having periodicity substantially aligned to the target system information transmission periodicity.

9. An access point in a frequency hopping communication system, comprising:
a wireless interface over which wireless communications with electronic devices are carried out across a system bandwidth in accordance with a frequency hopping sequence; and
a control circuit configured to control transmission of a system information by the access point, wherein the control circuit causes the access point to carry out the method according to claim 1.

10. A method of receiving system information in an electronic device operating in a wireless communication system having a frequency hopping sequence, comprising:
listening to frames transmitted within a frequency range of a hopping spectrum designated for transmission of system information; and
receiving the system information in at least one frame within the frequency range, wherein the at least one frame on which the system information is received is based at least in part on a target system information transmission periodicity.

11. The method of claim 10, wherein the frequency range is one or more channels of the hopping spectrum.

12. The method of claim 10, wherein the frequency range is based on a receiving bandwidth of the electronic device receiving the system information.

13. The method of claim 10, wherein listening to frames transmitted within the frequency range includes monitoring all channels of the frequency range in parallel.

14. The method of claim 10, wherein the at least one frame comprises a first frame in the frequency range following a target system information transmission occurrence, wherein the target system information transmission occurrence is based on the target system information transmission periodicity.

15. The method of claim 10, wherein the at least one frame comprises a frame within the frequency range that is nearest, in the time domain, to the target system information transmission occurrence.

16. An electronic device, comprising:
a wireless interface over which wireless communications with an access point are carried out across a system bandwidth in accordance with a frequency hopping sequence; and
a control circuit configured to control the electronic device, wherein the control circuit configures the electronic device to carry out the method according to claim 10.
